(19) United States
(12) Patent Application Publication
(10) Pub. No.: US 2026/0279002 A1
(43) Pub. Date: Sep. 17, 2026

(54) METHOD AND SYSTEM FOR REAL TIME IMAGE TRACKING

(71) Applicant: Flying Flamingos India Private Limited, Bangalore (IN)

(72) Inventors: Amit Gaiki, Bangalore (IN); Shourya Agarwal, Ajmer (IN); Prakharkumar Srivastava, Rajkot (IN)

(73) Assignee: Flying Flamingos India Private Limited, Bangalore, KA (IN)

(21) Appl. No.: 19/463,461

(22) Filed: Jan. 29, 2026

(30) Foreign Application Priority Data
Jan. 29, 2025 (IN) 202541007309

(51) Int. Cl. G06V 10/62; G06T 7/246; G06T 7/73; G06V 10/46; G06V 10/74; G06V 10/75

(52) U.S. Cl. CPC G06V 10/62; G06T 7/248; G06T 7/74; G06V 10/462; G06V 10/751; G06V 10/761; G06T 2207/10016; G06T 2207/20004

(57) ABSTRACT

The present disclosure relates to a system and a method for adaptive image tracking. The system includes one or more processors and a non-transitory memory for storing instructions. The instructions, when executed by the one or more processors, cause the system to receive, using a receiving module, a target image and a query image of a physical environment. The system detects, using a keypoint detection module, a plurality of keypoints in the target image, and generates, using a descriptor generation module, one or more descriptor distributions defining pixel-pair intensity relationships. The system computes binary descriptors, re-identifies keypoints of the target image in the query image, and evaluates the descriptor distributions to determine a suitability score. The system selects an optimal descriptor distribution and tracks the target image across frames for stable and illumination-robust mixed reality rendering.

### TECHNICAL FIELD

The present invention relates to the field of computer vision and image processing. More particularly, the present disclosure relates to a system and method for adaptive image tracking.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

Real-time image tracking is a critical component of various applications, including augmented reality, autonomous navigation, and video surveillance. However, existing solutions face significant challenges in balancing performance, accuracy, and memory efficiency. Current machine learning models used for image descriptor calculations often have substantial computational demands and large file sizes. This makes them unsuitable for low-end devices and limits their scalability for mass distribution. Additionally, the heavy computational load of these models requires high processing power, which is a barrier to achieving real-time performance in resource-constrained environments.

Another pressing issue is the latency associated with image tracking solutions. The preparation time for existing models typically ranges from 11 ms to 17 ms per frame, which is compounded by additional inference time, creating significant delays. To manage these delays, interpolation techniques are often employed, but they compromise the real-time nature and accuracy of the tracking process. Traditional algorithms, while free from some of the computational burdens of machine learning models, often have intricate control flows that hinder their compatibility with efficient SIMD implementations. This inefficiency exacerbates the time and resource requirements of real-time tracking.

Moreover, existing methods are designed for generalized use cases rather than being optimized for specific image tracking scenarios. This lack of specialization results in suboptimal performance when tracking and detecting singular images. To compensate for these limitations, traditional and machine learning-based methods frequently rely on optical flow techniques, which reduce tracking accuracy in dynamic and variable environments.

In light of the above, there is a need for a method and system that overcomes the above stated problem statements.

### SUMMARY

In an aspect, the present disclosure provides a system for adaptive image tracking. The system includes one or more processors and a non-transitory memory communicatively coupled to the one or more processors. The memory stores instructions which, when executed, cause the system to receive, using a receiving module, a target image and a query image of a physical environment captured by one or more sensors of a user device. The target image represents a reference view and the query image represents a physical region containing the target image. The system detects, using a keypoint detection module, a plurality of keypoints in the target image. Further, the system generates, using a descriptor generation module, one or more descriptor distributions for each of the detected plurality of keypoints. Each of the one or more descriptor distributions defines a spatial sampling pattern of pixel-pair intensity relationships around the plurality of keypoints. The system computes, using a feature computation module, one or more binary descriptors based on the generated one or more descriptor distributions. The system re-identifies, using a re-identification module, the plurality of keypoints of the target image in the query image by comparing the one or more binary descriptors computed from the query image with the stored one or more binary descriptors corresponding to the target image. The system evaluates, using a scoring module, the one or more descriptor distributions associated with the re-identified plurality keypoints to determine a distribution suitability score. In addition, the system selects, using a distribution selection module, an optimal descriptor distribution for the query image based on the determined suitability score. The system tracks, using a tracking module, the target image across a sequence of frames captured by the user device. The tracking is done based on point-to-point correspondence between the one or more binary descriptors derived from the selected descriptor distribution.

In an embodiment of the present disclosure, the descriptor distributions are generated using a parameterized spatial function defining a pixel sampling pattern based on at least one of amplitude, frequency, or phase offset parameters.

In an embodiment of the present disclosure, the system evaluates the descriptor distributions using one or more performance parameters. The one or more performance parameters include re-identification accuracy, tracking stability, affine-transformation tolerance, descriptor distinctiveness, and illumination robustness.

In an embodiment of the present disclosure, the feature computation module generates the one or more binary descriptors by comparing relative pixel-intensity pairs within each sampling pattern. The comparison produces rotation-and scale-invariant descriptor encodings.

In an embodiment of the present disclosure, the re-identification module performs descriptor matching using a nearest-neighbor search or a Hamming-distance-based similarity computation. The descriptor matching is done between the one or more binary descriptors of the query image and the stored one or more binary descriptors of the target image.

In an embodiment of the present disclosure, the system stores the one or more descriptor distributions for each of the plurality of keypoints. The system dynamically switches to an alternate descriptor distribution when the suitability score associated with the re-identified plurality of keypoints falls below a pre-defined threshold.

In an embodiment of the present disclosure, the scoring module assigns the weighted distribution suitability score based on a combination of descriptor distinctiveness and temporal stability of the re-identified plurality of keypoints across a plurality of frames of the query image.

In an embodiment of the present disclosure, the tracking module performs geometric consistency verification by estimating a homography matrix from matched descriptor pairs. In addition, the tracking module rejects outlier correspondences exceeding a defined deviation threshold.

In an embodiment of the present disclosure, the system continuously updates the descriptor distribution suitability score based on temporal frame analysis. The system updates the suitability score to maintain tracking stability under dynamic illumination or motion variations.

In an embodiment of the present disclosure, the re-identification module constructs a mapping matrix between the matched descriptor pairs of the target image and the query image. The mapping matrix represents a geometric transformation derived from the descriptor correspondences.

In an embodiment of the present disclosure, the tracking module projects the matched keypoints into a three-dimensional coordinate system using intrinsic and extrinsic camera parameters. The tracking module continuously tracks a spatial position of the query image within the three-dimensional scene using the mapped descriptors.

In another aspect, the present disclosure provides a method for performing adaptive image tracking. The method includes a first step of detecting a plurality of keypoints in a target image captured by one or more sensors of a user device. Further, the method includes a second step of generating one or more descriptor distributions for each of the detected plurality of keypoints. Each of the one or more descriptor distributions defines a spatial sampling pattern of pixel-pair intensity relationships around the plurality of keypoints. In addition, the method includes a third step of computing one or more binary descriptors for the plurality of keypoints based on the generated one or more descriptor distributions. The one or more binary descriptors represent local intensity comparisons around each of the plurality of keypoints. Moreover, the method includes a fourth step of receiving a query image of a physical environment captured by the one or more sensors. Furthermore, the method includes a fifth step of re-identifying the plurality of keypoints of the target image in the query image. The re-identification is done by comparing the one or more binary descriptors computed from the query image with the stored one or more binary descriptors corresponding to the target image. Also, the method includes a sixth step of evaluating the one or more descriptor distributions associated with the re-identified plurality of keypoints to determine a distribution suitability score. Further, the method includes a seventh step of selecting an optimal descriptor distribution for the query image based on the determined suitability score. Moreover, the method includes an eighth step of tracking the target image across a sequence of frames captured by the user device based on point-to-point correspondence between the one or more binary descriptors derived from the selected descriptor distribution.

In an embodiment of the present disclosure, the one or more descriptor distributions are generated using a parameterized spatial function defining a pixel sampling pattern based on at least one of amplitude, frequency, or phase offset parameters.

In an embodiment of the present disclosure, evaluating the one or more descriptor distributions includes computing one or more performance parameters, the one or more performance parameters include re-identification accuracy, tracking stability, affine-transformation tolerance, descriptor distinctiveness, and illumination robustness.

In an embodiment of the present disclosure, computing the one or more binary descriptors includes comparing relative pixel-intensity pairs within each sampling pattern to produce rotation-invariant and scale-invariant descriptor encodings.

In an embodiment of the present disclosure, the method further includes storing the one or more descriptor distributions for each of the plurality of keypoints and dynamically switching to an alternate descriptor distribution when the distribution suitability score falls below a predefined threshold.

In an embodiment of the present disclosure, the distribution suitability score is determined based on a combination of descriptor distinctiveness and temporal stability of the re-identified plurality of keypoints across a plurality of frames of the query image.

In an embodiment of the present disclosure, the descriptor distribution suitability score is updated continuously based on temporal frame analysis to maintain tracking stability under dynamic illumination variations or motion conditions.

In an embodiment of the present disclosure, the tracking of the target image comprises projecting matched keypoints into a three-dimensional coordinate system using intrinsic and extrinsic camera parameters and continuously estimating a spatial position of the query image within the three-dimensional scene using the mapped descriptors.

### BRIEF DESCRIPTION OF DRAWINGS

Having thus described the disclosure in general terms, references will now be made to the accompanying figures, wherein:

FIG. 1 illustrates an exemplary environment for enabling adaptive image tracking, in accordance with various embodiments of the present disclosure;

FIG. 2 illustrates a functional block diagram of a system for performing the adaptive image tracking, in accordance with various embodiments of the present disclosure;

FIG. 3A illustrates a first portion of a process flow diagram of a method for performing the adaptive image tracking, in accordance with various embodiments of the present disclosure;

FIG. 3B illustrates a second portion of the process flow diagram of a method for performing the adaptive image tracking, in accordance with various embodiments of the present disclosure; and

FIG. 4 illustrates an exemplary schematic representation showing multiple intensity point distributions around a keypoint within a target image, in accordance with an embodiment of the present disclosure;

FIG. 5 illustrates an exemplary schematic representation showing keypoint correspondence between a target image and a query image, in accordance with an embodiment of the present disclosure;

FIG. 6 illustrates an exemplary schematic representation showing another example of keypoint correspondence between another target image and another query image, in accordance with another embodiments of the present disclosure; and

FIG. 7 illustrates an exemplary block diagram of an exemplary device for executing the adaptive image tracking, in accordance with various embodiments of the present disclosure.

It should be noted that the accompanying figures are intended to present illustrations of exemplary embodiments of the present disclosure. The figures are not intended to limit the scope of the present disclosure. It should be noted that accompanying figures are not necessarily drawn to scale.

### DETAILED DESCRIPTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers, or steps. Likewise, the term “comprising” is considered synonymous with the terms “including” or “containing” for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. The values and ranges are to be treated as examples only, and are not intended to limit the scope of the claims. In addition, a number of system architectures are identified as suitable for various facets of the implementations. The system architectures are to be treated as exemplary and are not intended to limit the scope of the invention.

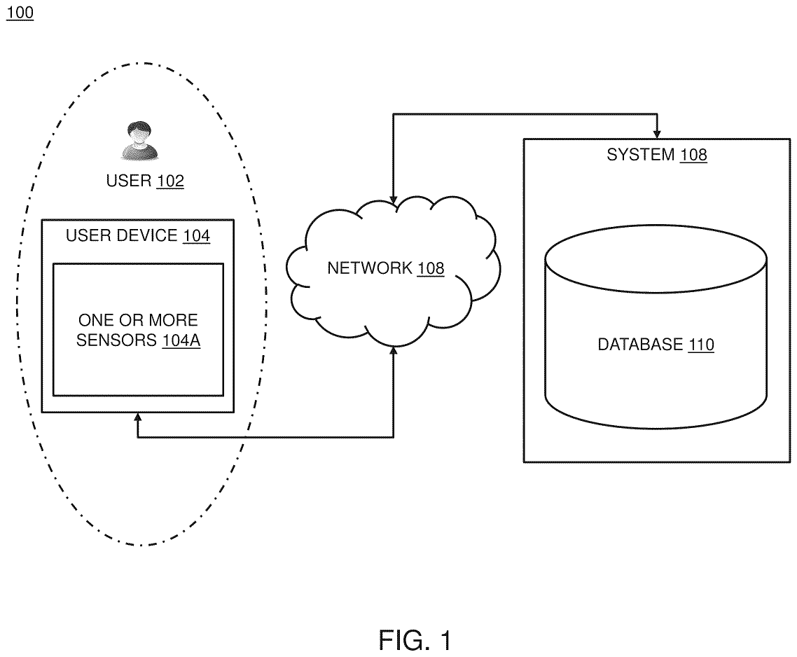

FIG. 1 illustrates an exemplary environment for enabling adaptive image tracking, in accordance with various embodiments of the present disclosure. The exemplary environment 100 includes a user device 104 associated with a user 102, a communication network 106, a system 108, and a database 110. The adaptive image tracking environment 100 provides an operational framework for capturing, analyzing, and re-identifying visual regions across multiple image frames. The operational framework enables the re-identification of the visual regions using dynamically generated descriptor distributions.

The user 102 interacts with the user device 104 to capture one or more images of a physical environment. The user device 104 is a computing platform configured to acquire visual input, process extracted features, and communicate tracking data with the system 108. Examples of the user device 104 include smartphones, tablets, head-mounted displays, augmented-reality glasses, or any portable imaging apparatus capable of real-time camera operation.

The user device 104 includes one or more sensors 104A that capture spatial, visual, and positional information of the environment. The one or more sensors 104A may include at least an RGB camera for image acquisition, a depth sensor for estimating object distance, and an inertial measurement unit (IMU) for orientation tracking. The one or more sensors 104A generate a target image representing a reference view and a query image representing a broader or updated region of the same environment that contains the target image. These captured images are transmitted through the communication network 106 for processing and tracking.

The communication network 106 provides bidirectional connectivity between the user device 104 and the system 108. The communication network 106 may include one or more of Wi-Fi, 5G, LTE, Bluetooth, or satellite links supporting low-latency data transmission. The network layer ensures reliable delivery of image data, descriptor packets, and tracking metadata necessary for maintaining synchronization between consecutive frames captured by the one or more sensors 104A.

The system 108 is a computational entity configured to perform adaptive image tracking based on descriptor distribution-driven re-identification of keypoints. The system 108 may be implemented as an edge-processing module on the user device 104, a local workstation, or a cloud-based processing node. The system 108 cooperates with the user device 104 to detect keypoints in the target image, generate descriptor distributions, compute binary descriptors, re-identify keypoints within the query image, and track the target image across a sequence of frames.

The database 110 stores reference descriptors, distribution templates, and historical tracking parameters. The database 110 maintains records of descriptor suitability scores, performance metrics, and threshold parameters used for optimizing re-identification accuracy under variable illumination or motion conditions. The database 110 may be local to the user device 104 or hosted remotely to enable synchronized descriptor sharing across multiple devices.

In operation, the user 102 initiates a tracking session by aligning the user device 104 toward a region of interest. The one or more sensors 104A capture a frame designated as the target image, which is analyzed by the system 108 to detect keypoints and compute descriptor distributions defining the intensity-pair sampling pattern around each keypoint. The resulting binary descriptors are stored in association with the target image and serve as the reference representation for future comparisons.

When subsequent frames of the same environment are captured, the system 108 designates them as query images. The system 108 compares descriptors derived from the query image with those stored from the target image to re-identify the same keypoints under changes in perspective, scale, or illumination. The re-identification results are scored based on descriptor suitability metrics and used to determine the optimal descriptor distribution for maintaining robust tracking.

The adaptive tracking process supports real-time performance by updating descriptor parameters dynamically according to scene conditions. The system 108 may assign weights to each descriptor distribution based on temporal stability, distinctiveness, and resistance to affine or photometric variations. These adaptive updates ensure that the keypoints remain accurately aligned across frames, enabling smooth tracking even when lighting or viewpoint changes occur.

In some embodiments, the system 108 operates in a distributed configuration where the descriptor generation and tracking computations are performed on the user device 104, while descriptor optimization and archival storage are handled by a cloud-hosted database 110. This distributed execution reduces on-device computational load while maintaining real-time responsiveness.

The communication network 106 enables feedback synchronization between the user device 104 and the system 108. For example, when the suitability score of a descriptor distribution falls below a threshold, the system 108 transmits adjustment parameters to the user device 104 for regenerating optimized distributions. This bidirectional feedback loop enables continuous refinement of tracking precision without manual recalibration.

In another embodiment, the environment 100 supports multi-user or multi-device synchronization. Multiple user devices 104 may simultaneously capture overlapping scenes and transmit keypoint data to a shared system 108. The system 108 correlates re-identified keypoints across devices to enhance overall scene reconstruction and multi-angle tracking performance.

For instance, when the user 102 captures a physical marker in a real-world environment, the target image is processed by the system 108 to generate initial descriptors. As the user 102 moves, subsequent query images are captured, and the system 108 re-identifies the same keypoints even if the marker is partially occluded or viewed from a different angle. The adaptive image tracking environment 100 ensures that the system 108 maintains stable correspondence between the target image and its representation within successive frames, thereby enabling accurate localization and scene awareness.

In certain implementations, the system 108 may communicate with additional auxiliary data repositories such as training databases containing pre-generated descriptor distributions or machine-learning models optimized for specific environmental contexts. The system 108 leverages these auxiliary sources to fine-tune descriptor generation parameters for different texture densities, lighting conditions, or motion dynamics.

The adaptive image tracking environment 100 thus establishes a comprehensive computational framework enabling real-time, descriptor-based correspondence tracking between a reference image and a live captured scene. By dynamically generating, evaluating, and adapting descriptor distributions, the system 108 achieves consistent keypoint re-identification across varying environmental conditions, providing the foundation for accurate localization, augmented-reality alignment, and mixed-reality content stabilization.

While FIG. 1 illustrates a single user 102 operating a single user device 104, multiple users may simultaneously interact with corresponding devices across the communication network 106. Each device 104 independently performs image capture and local processing, while sharing descriptor parameters or suitability metrics with the system 108 to ensure collaborative consistency across sessions.

The number and arrangement of systems, devices, and networks shown in FIG. 1 are exemplary and may vary depending on implementation scenarios. Additional computing nodes, distributed descriptor caches, or edge-processing gateways may be incorporated to enhance scalability. Alternatively, the descriptor generation or scoring functions of the system 108 may be distributed across hybrid cloud infrastructures to balance computation and reduce latency across heterogeneous device ecosystems.

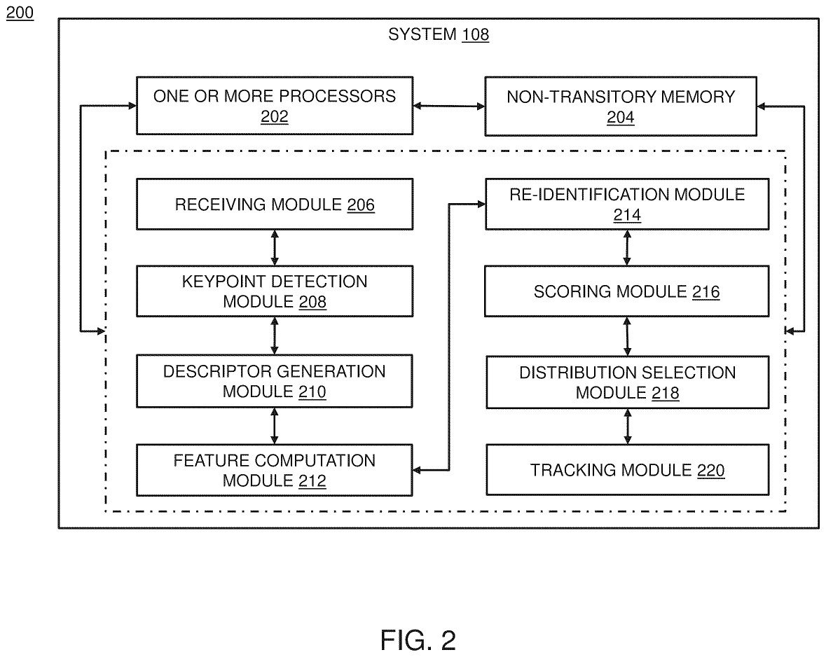

FIG. 2 illustrates a detailed functional block diagram of the system 108 for performing the adaptive image tracking, in accordance with various embodiments of the present disclosure. The system 108 executes a modular processing pipeline that enables accurate keypoint detection, descriptor generation, re-identification, and continuous tracking of a target image within a physical environment. The adaptive image tracking is performed using sinusoidal descriptor distributions and descriptor-based re-identification.

The system 108 includes one or more processors 202 operatively coupled to a non-transitory memory 204. The non-transitory memory 204 stores program instructions. The one or more processors 202 execute the program instructions. The program instructions direct the system 108 to perform the adaptive image tracking operations on the image data captured by the one or more sensors 104A of the user device 104. In order to explain the system elements of FIG. 2, references will be made to the elements of FIG. 1 for clarity and ease of understanding.

The system 108 includes a modular processing pipeline executed by the one or more processors 202. The one or more processors 202 execute the modular processing pipeline using program instructions stored in the non-transitory memory 204. The modular processing pipeline includes a plurality of system modules configured to execute distinct image-processing operations in a logically sequential manner. The plurality of system modules include a receiving module 206, a keypoint detection module 208, a descriptor generation module 210, a feature computation module 212, and a re-identification module 214. In addition, the plurality of system modules include a scoring module 216, a distribution selection module 218, and a tracking module 220. The above-mentioned system elements are exemplary and non-limiting. Additional or alternative modules may be incorporated within the system 108 in other implementations to support distributed processing or descriptor optimization.

The plurality of system modules are operatively coupled in a sequential and feedback-driven architecture. Each module of the plurality of system modules produces outputs that serve as standardized inputs for subsequent modules. The plurality of system modules are configured to interact with one another to establish a structured workflow for keypoint detection, descriptor distribution generation, and adaptive tracking of a target image. The block diagram of FIG. 2 illustrates the plurality of system modules as part of the system 108. However, additional support modules may be included depending on deployment requirements, environmental conditions, or precision tracking scenarios.

The interaction between the plurality of system modules forms a continuous data flow within the modular processing pipeline of the system 108. The plurality of system modules are collectively configured to capture image inputs from the user device 104, detect visual keypoints, compute binary descriptors, and track the position of a target image across multiple frames. Each system module executes a specialized function and exposes standardized outputs to downstream modules through well-defined interfaces. The modular approach ensures low-latency operation, reconfigurability, and extensibility of components for high-speed tracking performance.

The elements of the system 108 described herein are operatively coupled to enable end-to-end adaptive image tracking of the target image within the query image captured by the user device 104. The one or more processors 202 orchestrate the operation of the system modules by executing the program instructions stored in the non-transitory memory 204. The execution flow begins with the reception of the target image and query image, proceeds through keypoint detection, descriptor computation, and re-identification stages, and culminates in the tracking of the target image across sequential frames. Each module in the architecture operates either independently or cooperatively with adjacent modules depending on runtime conditions, computational availability, and environmental variability.

The non-transitory memory 204 stores instructions that, when executed, cause the one or more processors 202 to perform dynamic keypoint detection and descriptor generation based on one or more images received from the sensors 104A in real time. The one or more processors 202 are operably coupled with the receiving module 206, the keypoint detection module 208, the descriptor generation module 210 and the feature computation module 212. In addition, the one or more processors 202 are operably coupled with the re-identification module 214, the scoring module 216, the distribution selection module 218, and the tracking module 220. The one or more processors 202 coordinate data flow among the modules and performs internal synchronization of descriptor updates for maintaining continuous tracking stability.

The elements of the system 108 collectively operate in synchronization to enable the user 102 to achieve robust and reliable image tracking under varying environmental conditions. The system 108 may be deployed within a distributed computing environment that includes the user device 104, an edge-processing unit integrated with the tracking engine, and a remote server operably coupled with the database 110. The system 108 executes within a transient runtime on the user device 104 and selectively updates descriptor distributions and re-identification results based on real-time sensor inputs and evaluation feedback.

The non-transitory memory 204 stores instructions that, when executed, cause the one or more processors 202 to perform a series of operations for enabling the descriptor-based re-identification and the adaptive tracking. The tracking refers to maintaining consistent correspondence between the keypoints of the target image and the corresponding regions in the query image. The descriptors represent compact binary encodings of local pixel-intensity patterns and are continuously refined to accoun0074 for geometric and illumination variations. The adaptive framework dynamically evaluates descriptor suitability and updates distribution parameters to sustain accurate tracking performance in mixed lighting, motion, and perspective conditions.

The one or more processors 202, using the receiving module 206, receive a target image and a query image of a physical environment captured by one or more sensors 104A of a user device 104. The target image represents a reference view of a physical region. The query image represents a subsequent or extended region that contains the target image. In addition, the target image refers to a known or reference frame whose visual features are to be tracked. The query image denotes a current frame captured during runtime. In an example, the target image may correspond to a pre-stored visual reference of an object, such as a company logo, a product label, a printed poster, or a physical marker placed within a scene. Also, the target image may represent a reference surface such as a wall texture, a signboard, or a three-dimensional object captured under controlled lighting during a calibration phase.

In another example, the query image may correspond to a live camera frame captured by the user device 104 while scanning the physical environment containing the target image. For instance, when a user points a smartphone camera toward a storefront poster previously stored as the target image, the current camera feed represents the query image. The query image dynamically reflects real-world conditions such as lighting, viewpoint, and partial occlusions. The target image serves as a fixed reference against which re-identification and tracking are performed.

In an embodiment of the present disclosure, the target image may be locally stored in the non-transitory memory 204 or fetched from the database 110. The query image is acquired in real time through the one or more sensors 104A. Collectively, the target image and query image enable the system 108 to perform keypoint detection, descriptor computation, and adaptive tracking across frames of a video sequence or during a mixed reality session.

The receiving module 206 manages data acquisition, frame buffering, and synchronization of image sequences captured under varying illumination or motion conditions. In some embodiments, the receiving module 206 performs noise filtering, brightness normalization, and geometric correction on the received images to ensure consistent feature extraction.

In an embodiment, the receiving module 206 performs frame acquisition, timestamp alignment, and image normalization before forwarding data downstream. For example, the receiving module 206 may apply geometric rectification to correct lens distortion and exposure compensation to stabilize luminance levels between frames. The received images are buffered in synchronized queues to maintain temporal consistency when processing high-frame-rate video inputs.

The system 108 operates in real time, capturing a continuous sequence of query images from the one or more sensors 104A. In an embodiment of the present disclosure, the receiving module 206 performs exposure normalization to compensate for lighting variation between frames. In another embodiment, the receiving module 206 may perform frame differencing to detect significant scene change and trigger re-initialization of the descriptor pipeline only when necessary, optimizing processing efficiency. For example, when the user device 104 transitions from indoor to outdoor lighting, the receiving module 206 may compute a histogram equalization map to balance the overall intensity before transmitting the frames to the next module.

The system 108 operates in real time, capturing a continuous sequence of query images from the one or more sensors 104A. In an embodiment of the present disclosure, the receiving module 206 performs exposure normalization to compensate for lighting variation between frames. In another embodiment, the receiving module 206 performs frame differencing to detect significant scene change and trigger re-initialization of the descriptor pipeline when necessary, optimizing processing efficiency. For example, when the user device 104 transitions from indoor to outdoor lighting, the receiving module 206 may compute a histogram equalization map to balance the overall intensity before transmitting the frames to the next module.

The one or more processors 202, using the keypoint detection module 208, detect a plurality of keypoints in the target image. The plurality of keypoints represent distinct visual features such as corners, edges, or texture discontinuities that remain stable under rotation or scale changes. In addition, a keypoint refers to a pixel-level location that exhibits locally distinctive intensity variation in corners, blobs, or textured points that remain repeatable under rotation or scale change. The keypoint detection module 208 may employ gradient-based detectors such as Harris, FAST, or Difference-of-Gaussian (DoG) filters, or trainable convolutional kernels that highlight salient features. In an embodiment, each of the detected plurality of keypoints is assigned attributes such as orientation, scale, and response, forming a keypoint map. For instance, in a 640×480 frame, approximately 800 keypoints may be extracted, each describing regions rich in spatial contrast. The keypoint detection module 208 outputs a keypoint map for subsequent descriptor generation.

In an embodiment of the present disclosure, the keypoint detection module 208 may dynamically adjust the detection threshold based on scene texture density and motion speed. The dynamic adjustment maintains an optimal number of keypoints for efficient tracking. For example, in a low-texture environment such as a wall, the threshold is reduced to retain minor intensity variations, while in a highly textured scene, only the most stable keypoints are preserved. In another embodiment, the keypoint detection module 208 may apply non-maximum suppression within a local neighborhood window to ensure spatial uniformity among the detected keypoints. The suppression technique prevents clustering and improves geometric spread across the target image.

The one or more processors 202, using the descriptor generation module 210, generate one or more descriptor distributions for each of the detected plurality of keypoints. Each descriptor distribution defines a spatial sampling pattern of pixel-pair intensity relationships around the keypoints. A descriptor distribution is a two-dimensional arrangement specifying where pixel-pair comparisons occur relative to a keypoint. In an embodiment of the present disclosure, the descriptor generation module 210 generates the descriptor distributions using a parameterized spatial function. The parameterized spatial function defines a pixel sampling pattern based on at least one of amplitude, frequency, or phase offset parameters. Accordingly, the parameterization forms tunable sampling geometries (circular, spiral, or radial). In addition, the descriptor generation module 210 adapts the sampling configuration according to local texture density and lighting variation to enhance descriptor robustness.

The parameterized spatial function establishes the geometric relationship between sampling points surrounding each keypoint. The amplitude parameter controls a radial distance of sampling points from the keypoint center, defining the scale of the local region being analyzed. The frequency parameter determines a number of pixel pairs distributed along a sampling circle or spiral, for influencing descriptor granularity. The phase offset parameter defines an angular displacement between consecutive sampling points to improve rotational diversity in the generated distribution.

In an embodiment of the present disclosure, the descriptor generation module 210 defines the spatial sampling pattern using a sinusoidal modulation function expressed as: I(θ)=A·sin(θ+φ)+B·sin(θ+α),

where A and B represent amplitude coefficients controlling sampling radius, θ denotes the angular displacement around the keypoint, and φ and α represent phase offsets controlling directional sampling bias. The use of sine-wave modulation enables smooth, non-linear intensity sampling that captures both radial and angular luminance variations surrounding the keypoint. The use of sine-wave modulation enhances descriptor robustness to the affine transformations, the lens distortions, and the non-uniform lighting conditions. The amplitude parameters are adaptively scaled based on the keypoint size or local image resolution to maintain descriptor consistency across varying scales.

For example, a circular pattern with amplitude 12 pixels and frequency 8 defines eight equidistant pixel-pairs around the keypoint, while varying the phase offset introduces shifted sampling orientations for improved rotational invariance. In an embodiment, the descriptor generation module 210 adjusts these parameters adaptively based on texture density. High-texture regions are assigned higher frequencies and lower amplitudes to capture fine variations, whereas low-texture areas use larger amplitudes and lower frequencies for stability. The parameterization of the descriptor distribution ensures flexibility in representing image features under different illumination and geometric conditions.

In an example, in high-texture regions, the descriptor generation module 210 may generate dense concentric rings of sampling points, while in low-texture regions a sparse radial pattern minimizes redundancy. The patterns are encoded as coordinate templates stored in the non-transitory memory 204 and reused across frames for computational efficiency.

In another examples, a “high-frequency” descriptor distribution might generate 512 pixel-pair comparisons per keypoint for fine-grained textures, while a “low-frequency” distribution might use 128 pairs to save computation for smoother regions.

The one or more processors 202, using the feature computation module 212, compute one or more binary descriptors for the plurality of keypoints based on the generated descriptor distributions. Each binary descriptor represents the relative comparison of pixel intensities at pre-defined locations within the sampling pattern. The binary descriptor denotes a bit-string where each bit results from comparing intensities within a pixel pair defined by the sampling pattern. The feature computation module 212 converts the comparisons into compact binary codes that are rotation-and scale-invariant.

In an embodiment of the present disclosure, the feature computation module 212 utilizes the sinusoidally defined sampling distribution to compute the one or more binary descriptors based on intensity comparisons between paired points along the wave trajectory. Each descriptor bit encodes whether the sampled intensity at I(θ₁) exceeds that at I(θ₂), embedding both local contrast and periodic variation information into the descriptor vector. The sinusoidal trajectory allows multi-frequency analysis of local textures. In addition, the sinusoidal trajectory makes the descriptors more discriminative under brightness and illumination changes.

The feature computation module 212 transforms continuous intensity data into compact binary codes. The binary codes may be 256 or 512 bits long. In addition, the feature computation module 212 performs normalization and orientation alignment. The alignment ensures that the resulting descriptor to remain invariant to rotation, scale, and brightness shifts. For example, comparing 128 pixel pairs yields a 128-bit descriptor that can be matched using fast Hamming-distance operations. The generated one or more binary descriptors form a local representation of the target image's visual structure.

In an embodiment of the present disclosure, the feature computation module 212 generates the binary descriptors by comparing relative pixel-intensity pairs within each sampling pattern. The comparison produces rotation-and scale-invariant descriptor encodings. Each comparison results in a binary decision, forming a bit-string representation of the keypoint neighborhood.

For example, for a descriptor of length 256, the feature computation module 212 compares 256 pixel pairs distributed within a 16×16 region around the keypoint. In another example, given two pixels I₁ and I₂ sampled from the pattern, a binary value of 1 is assigned when I₁>I₂, and 0 otherwise. The operation is repeated across multiple pixel-pairs defined by the descriptor distribution. The resulting bit-string represents a distinctive visual signature that can be efficiently matched using Hamming distance.

In an embodiment of the present disclosure, the feature computation module 212 normalizes pixel intensity values using Gaussian weighting to reduce sensitivity to illumination noise. Also, the feature computation module 212 may align the sampling pattern orientation to a dominant gradient direction of the keypoint for achieving rotation invariance. Scale invariance is achieved by dynamically resizing the sampling region proportional to the detected keypoint scale parameter. The combined normalization techniques ensure that the generated binary descriptors remain stable under real-world environmental variations. In an embodiment of the present disclosure, the feature computation module 212 performs bit reordering and hashing to improve descriptor distinctiveness. Each descriptor is associated with metadata containing orientation and scale data.

The one or more processors 202, using the re-identification module 214, re-identify the plurality of keypoints of the target image in the query image. The re-identification module 214 compares the one or more binary descriptors computed from the query image with the stored binary descriptors corresponding to the target image. In an embodiment of the present disclosure, the re-identification module 214 performs the descriptor matching using a nearest-neighbor search or a Hamming-distance-based similarity computation. The descriptor matching is done between the one or more binary descriptors of the query image and the stored one or more binary descriptors of the target image

The Hamming distance metric quantifies the dissimilarity between binary strings by counting differing bits. A smaller distance value signifies stronger similarity between the one or more binary descriptors. In an embodiment, the re-identification module 214 performs a nearest-neighbor search to locate, for each descriptor in the query image, the most similar descriptor in the target image within a predefined distance threshold.

For instance, if two 256-bit descriptors differ by fewer than 25 bits, the descriptors are classified as corresponding matches. The matched pairs represent consistent keypoints across images captured under varying perspectives. In another embodiment, the re-identification module 214 employs an approximate nearest neighbour search index to accelerate comparison among large descriptor sets. The nearest neighbour search ensures real-time matching performance during continuous video tracking. The re-identification module 214 locates corresponding keypoints in the query image even under translation, rotation, or illumination shifts. The re-identification process enables consistent mapping of the target image region within the broader query frame.

In an embodiment of the present disclosure, the re-identification module 214 constructs a mapping matrix between the matched descriptor pairs of the target image and the query image. The mapping matrix represents a geometric or affine transformation that aligns the spatial coordinates of the two images based on the matched keypoints. The mapping may be estimated using a homography computation, least-squares fitting, or a RANSAC-based optimization routine to remove mismatched pairs. The resulting transformation enables the recognition of the query image region within the target image, and forms the basis for subsequent tracking operations.

The one or more processors 202, using the scoring module 216, evaluate the one or more descriptor distributions associated with the re-identified plurality of keypoints. The evaluation is done to determine a distribution suitability score. The distribution suitability score represents a quantified measure of how effectively a descriptor distribution performs under current environmental and imaging conditions. The scoring module 216 analyses a feature-level, frame-level, and temporal metrics associated with the one or more descriptor distributions. Accordingly, the scoring module 216 computes the distribution suitability score. The distribution suitability score reflects performance stability, repeatability, and matching robustness.

The scoring process begins once the re-identification module 214 establishes the keypoint correspondences between the target image and the query image. For each re-identified keypoint, the scoring module 216 aggregates comparison statistics such as descriptor confidence, match count, and persistence across frames. The metrics are combined using adaptive weighting factors stored in the non-transitory memory 204.

In an embodiment of the present disclosure, the scoring module 216 computes the suitability score using one or more performance parameters. The one or more performance parameters may include re-identification accuracy, tracking stability, affine-transformation tolerance, descriptor distinctiveness, and illumination robustness. Each parameter contributes a weighted component to the overall suitability score. The scoring module 216 stores the suitability score in the database 110 for ongoing performance analysis and adaptive updates.

The re-identification accuracy represents a proportion of matched keypoints between the target image and the query image that remain consistent over time. The tracking stability measures a degree to which the plurality of keypoints retain correspondence across multiple consecutive frames. The affine-transformation tolerance reflects an ability of the descriptors to remain invariant under perspective distortions such as rotation, scaling, or shearing. The descriptor distinctiveness is computed based on inter-descriptor correlation to assess uniqueness among descriptors within the same frame. The illumination robustness quantifies how well the descriptor distribution maintains matching performance under brightness or color shifts. For example, during outdoor-to-indoor transitions, when lighting contrast changes abruptly, the scoring module 216 assigns higher weight to the illumination robustness parameter and correspondingly lower weight to the affine-transformation tolerance parameter.

In an embodiment of the present disclosure, the scoring module 216 assigns the weighted distribution suitability score based on a combination of descriptor distinctiveness and temporal stability. The descriptor distinctiveness and temporal stability are associated with the re-identified plurality of keypoints across a plurality of frames of the query image. The descriptor distinctiveness maybe calculated using intra-frame feature separability. The temporal stability is derived from inter-frame persistence probability. The weighted suitability score maybe computed using a normalization function dependent on the descriptor distinctiveness parameter, the temporal stability parameter, and dynamically adjustable coefficients. The function is determined based on the detected motion or illumination variance. For instance, when a moving vehicle causes fast frame changes, the scoring module 216 prioritizes the temporal stability, whereas in a static indoor scene, another adjustable coefficient is emphasized to ensure sharp feature separation.

In an embodiment of the present disclosure, the scoring module 216 continuously updates the descriptor distribution suitability score based on temporal frame analysis. The scoring module 216 may perform statistical aggregation across multiple frames to detect gradual deterioration in performance metrics such as reduced accuracy or increased feature drift. When the suitability score falls below a predefined confidence threshold, the scoring module 216 triggers a feedback signal to the distribution selection module 218 for recalibration.

For example, if the re-identification accuracy decreases by 15% over five consecutive frames, the system 108 interprets the event as descriptor degradation due to changing light or motion blur and updates the suitability score accordingly. The continuous update loop ensures sustained tracking reliability under varying environmental dynamics.

The one or more processors 202, using the distribution selection module 218, select an optimal descriptor distribution for the query image based on the determined suitability score. The distribution selection module 218 ensures that the active descriptor distribution used for tracking reflects the most stable and contextually appropriate sampling configuration for current image conditions. In addition, the distributor selection module 218 maintains a repository of previously generated descriptor distributions within the non-transitory memory 204.

In an embodiment, each stored distribution is associated with a historical performance profile. The historical performance profile contains average suitability scores across diverse environments. When a new suitability score is computed by the scoring module 216, the distribution selection module 218 compares the current performance against the stored historical performance profiles. The comparison is done to determine the most suitable configuration.

In an embodiment of the present disclosure, the system 108 stores the one or more descriptor distributions for each of the plurality of keypoints and dynamically switches to an alternate descriptor distribution. The dynamic switch takes place when the suitability score associated with the re-identified plurality of keypoints falls below a pre-defined threshold. The switching process is adaptive and non-disruptive and ensures continuity of feature tracking without requiring reinitialization.

For instance, when a reduction in the suitability score indicates that a high-frequency descriptor pattern is underperforming in a low-light environment, the system 108 switches to a low-frequency descriptor optimized for higher noise tolerance. The switching decision is performed by the distribution selection module 218 in near real-time to sustain tracking consistency.

In an embodiment of the present disclosure, the distribution selection module 218 may employ a hysteresis-based switching mechanism to prevent rapid oscillation between distributions. Once a switch is executed, the distribution selection module 218 enforces a minimum evaluation interval before the next re-selection for stabilizing the tracking pipeline.

In an embodiment, the distribution selection module 218 utilizes historical trend analysis to predict when a switch may be required based on observed descriptor degradation rates, reducing latency in adaptation. For example, if the suitability score decreases by more than 10% in successive frames, pre-emptive switching is initiated to preclude potential loss of track points.

The one or more processors 202, using the tracking module 220, track the target image across a sequence of frames captured by the user device 104. The tracking module 220 establishes point-to-point correspondence between the one or more binary descriptors derived from the selected descriptor distribution. The tracking module 220 receives validated matches from the re-identification module 214 and the optimal descriptor distribution selection from the module 218. Using the inputs, the tracking module 220 computes a transformation model that maps a coordinate system of the target image with a coordinate system of the query image. The transformation may be affine, projective, or homographic depending on scene geometry.

In an embodiment of the present disclosure, the tracking module 220 performs geometric consistency verification. The verification process includes estimating a homography matrix from matched descriptor pairs and rejecting outlier correspondences exceeding a defined deviation threshold. The homography matrix defines a projective transformation between two planes. The homography matrix defines a projective transformation between the coordinate space of the target image and the query image. In an embodiment of the present disclosure, the tracking module 220 may use a Random Sample Consensus (RANSAC) algorithm to compute the homography matrix. The algorithm iteratively selects subsets of matched points to estimate geometric models and rejects outliers that exceed the defined deviation threshold. For example, if 70% of matched points conform to a single geometric model with a pixel error less than 1.2, the homography is accepted as valid. Outlier matches, often caused by motion blur or reflections, are discarded to preserve tracking accuracy. The verified transformation parameters are used to update the target image position within the query image sequence.

In an embodiment of the present disclosure, the tracking module 220 utilizes the mapping matrix generated by the re-identification module 214. The mapping matrix is utilized to project the matched keypoints into a three-dimensional coordinate space. The projection is performed using intrinsic and extrinsic parameters of the camera obtained from the calibration data. The tracking module 220 continuously tracks the spatial position and the orientation of the query image within the three-dimensional scene using the code-mapped descriptors. The continuous tracking enables consistent 3D pose estimation and the dynamic tracking of the query image relative to the target image under motion, rotation, or viewpoint changes.

In another embodiment, the tracking module 220 employs Kalman filtering or optical flow prediction to refine trajectory smoothness across consecutive frames. The verified transformation parameters are passed to downstream modules for positional correction of rendered virtual elements in a mixed reality environment.

In an embodiment of the present disclosure, the system 108 continuously updates the descriptor distribution suitability score based on temporal frame analysis. The continuous update maintains tracking stability under dynamic illumination or motion variations. In another embodiment, the tracking module 220 applies Kalman filtering to smooth keypoint trajectories and prevent jitter caused by sensor noise. When rapid motion occurs, a motion-prediction model extrapolates keypoint positions, to allow the system 108 to maintain real-time responsiveness.

In an embodiment of the present disclosure, the system 108 executes the generation of the descriptor distributions and the re-identification of the keypoints locally on the user device 104. The system 108 offloads descriptor optimization and storage to a remote server to enable distributed and scalable mixed reality tracking. In an embodiment of the present disclosure, the remote server performs long-term evaluation of descriptor statistics, aggregates performance data from multiple user devices, and transmits updated configuration parameters back to the devices. The distributed processing reduces local computational load and memory usage while maintaining high-precision adaptation.

For instance, when multiple user devices track similar objects, the server may identify a superior descriptor configuration yielding higher average stability and push that configuration to all connected devices. The hybrid local-cloud design supports real-time performance and continuous learning without overloading the user device 104.

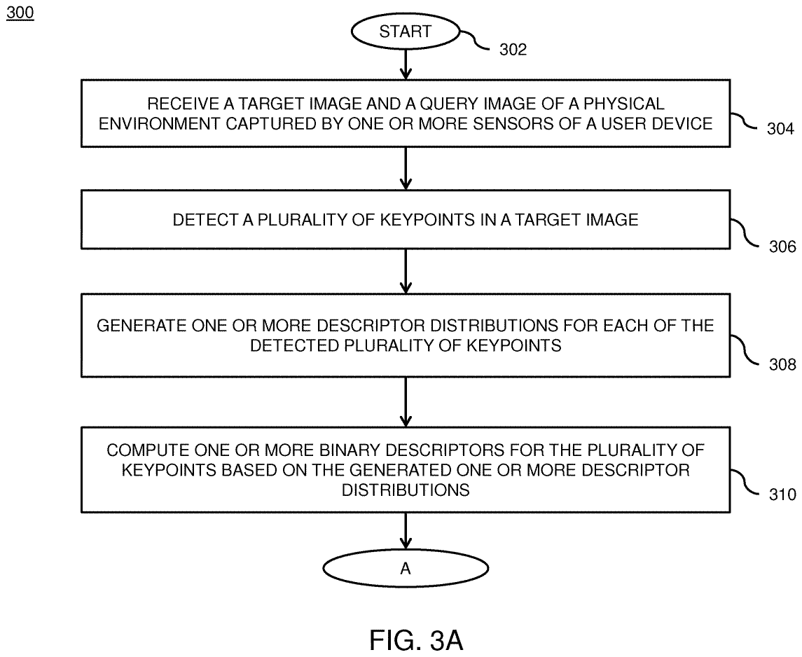

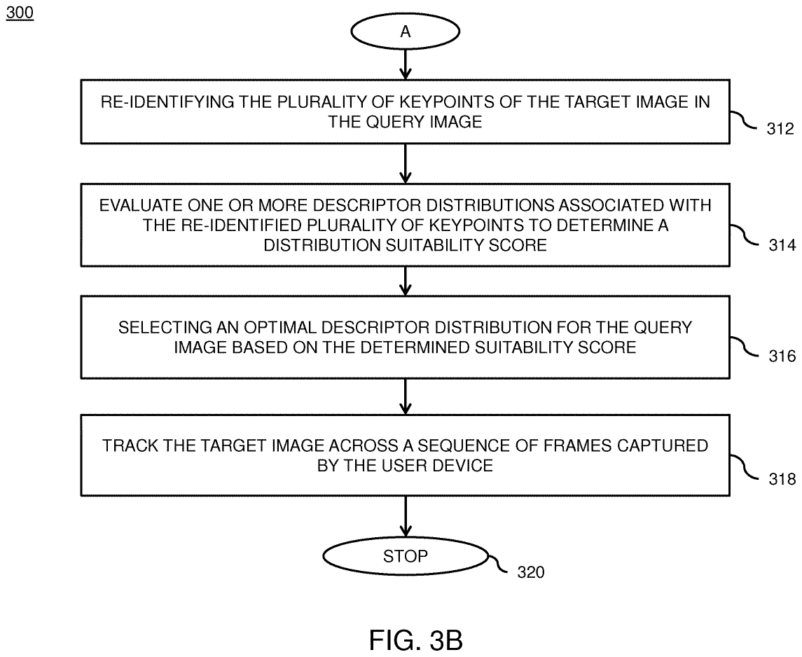

FIG. 3A and FIG. 3B illustrate a flowchart of a method 300 for performing the adaptive image tracking, in accordance with various embodiments of the present disclosure. It may be noted that the description of the flowchart refers to FIG. 1 and FIG. 2, and the working and functioning may be read together with the descriptions thereof. FIG. 3A illustrates a first portion of the flowchart comprising steps 302 through 310, and FIG. 3B illustrates a second portion of the flowchart comprising steps 312 through 320.

The flowchart initiates at step 302. At step 304, the method 300 includes receiving the target image and the query image of the physical environment captured by the one or more sensors 104A of the user device 104. The target image represents the reference view, and the query image represents the physical region containing the target image. In an embodiment of the present disclosure, the one or more sensors 104A include a camera, a depth sensor, or a stereo-vision unit. The target image and the query image serve as primary inputs for establishing the visual correspondence framework used for the adaptive image tracking.

At step 306, the method 300 includes detecting the plurality of keypoints within the target image. The plurality of keypoints represent distinct visual features such as corners, blobs, or edges that are invariant to illumination and viewpoint variations. In an embodiment, the detection of the plurality of keypoints is achieved using algorithms such as Difference-of-Gaussians (DoG), Harris Corner, or a convolutional neural network. The convolutional neural network maybe trained to identify salient feature points. Each detected keypoint provides a potential anchor for matching across frames.

At step 308, the method 300 includes generating the one or more descriptor distributions for each of the detected plurality of keypoints. Each descriptor distribution defines the spatial sampling pattern of the pixel-pair intensity relationships surrounding the keypoint. The descriptor generation module 210 constructs the descriptor distributions using the parameterized spatial function based on the amplitude, the frequency, and the phase offset parameters. In an embodiment of the present disclosure, the method include adaptively varying the parameters depending on the texture density or the illumination variance across image regions. For example, highly textured regions may use higher sampling frequencies to preserve detail, while uniform regions employ lower frequencies to reduce computational load.

At step 310, the method 300 includes computing the one or more binary descriptors for the plurality of keypoints based on the generated descriptor distributions. The computation involves performing the pixel-pair intensity comparisons within each sampling pattern. The comparison within each pattern outputs the single binary bit depending on the relative pixel intensity. The concatenated sequence of the binary comparisons forms the binary descriptor unique to each keypoint. In an embodiment, the computation incorporates the Gaussian weighting for the illumination normalization and the orientation alignment based on the gradient direction to ensure rotation and scale invariance.

At step 312, the method 300 includes re-identifying the plurality of keypoints of the target image within the query image. The re-identification module 214 compares the one or more binary descriptors computed from the query image with the stored one or more binary descriptors corresponding to the target image. In an embodiment, the matching process uses the Hamming-distance-based nearest neighbor search to establish correspondences between the descriptor pairs.

At step 314, the method 300 includes evaluating the one or more descriptor distributions associated with the re-identified plurality of keypoints to determine the distribution suitability score. The scoring module 216 computes the suitability score using the one or more performance parameters. The one or more performance parameters include the re-identification accuracy, the tracking stability, the affine-transformation tolerance, the descriptor distinctiveness, and the illumination robustness.

In an embodiment of the present disclosure, the suitability score is calculated using the weighted normalization. The one or more performance sensitive to the current environment are assigned higher weights. For example, in a scene with motion blur, tracking stability is prioritized, while in a static scene, descriptor distinctiveness is emphasized.

At step 316, the method 300 includes selecting the optimal descriptor distribution for the query image based on the determined suitability score. The distribution selection module 218 compares the current suitability score with the historical profiles stored in the memory 204. The comparison is done to determine the most efficient descriptor configuration. In an embodiment, the method include dynamically switching to the alternate descriptor distribution when the suitability score falls below the predefined threshold. For example, when a high-frequency descriptor pattern underperforms in low light, the distribution selection module 218 selects a lower-frequency descriptor optimized for illumination robustness.

At step 318, the method 300 includes tracking the target image across the sequence of frames captured by the user device 104. The tracking module 220 performs the point-to-point correspondence between the binary descriptors derived from the selected descriptor distribution. The tracking module 220 verifies the geometric consistency by estimating the homography matrix between the matched descriptor pairs and rejecting the outlier correspondences exceeding the deviation threshold. In an embodiment of the present disclosure, the Random Sample Consensus (RANSAC) algorithm is used to compute the transformation matrix and ensure the spatial coherence. The verified transformation parameters are utilized for the accurate object pose estimation and the scene alignment during the mixed reality rendering.

In an embodiment of the present disclosure, the method 300 further includes executing the generation of the descriptor distributions and the re-identification locally on the user device 104 and offloading optimization and long-term descriptor storage to the remote server. The distributed configuration enables scalable and low-latency operation across multiple user devices in real-time mixed reality environments.

The flowchart 300 terminates at step 320. The described steps collectively enable the real-time adaptive image tracking through dynamic descriptor distribution generation, continuous suitability evaluation, and context-driven descriptor selection. The method enhances robustness, maintains geometric consistency, and supports seamless tracking performance across variable illumination, motion, and environmental conditions.

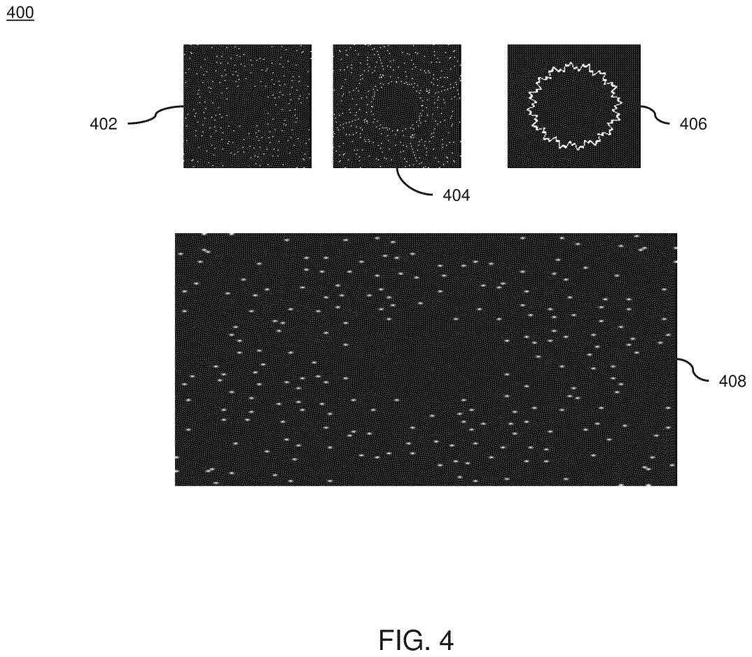

FIG. 4 illustrates an exemplary schematic representation 400 showing multiple intensity point distributions around a keypoint within the target image, in accordance with an embodiment of the present disclosure. The schematic representation 400 depicts three upper sub-figures 402, 404 and 406 corresponding to distinct intensity-point arrangements and a lower composite view 408 representing a cumulative distribution pattern. The intensity point distributions are generated by the descriptor generation module 210 and are used for forming the one or more descriptor distributions defining the pixel-pair intensity relationships around the detected plurality of keypoints.

The upper-left sub-figure 402 illustrates a uniform circular sampling configuration in which the intensity points are placed equidistantly around the keypoint to maintain rotational symmetry. The upper-middle sub-figure 404 shows a radial configuration having concentric sampling rings with varying point densities to capture multi-scale spatial characteristics. The upper-right sub-figure 406 depicts a spiral or phase-shifted sampling configuration enabling directional sensitivity for gradient-rich regions. The lower section 408 presents a large-scale cumulative distribution showing the combined spatial layout of intensity points generated across multiple keypoints in the target image.

Each configuration defines the pattern from which the pixel-pair intensity comparisons are computed to generate the one or more binary descriptors. The uniform circular distribution ensures the geometric invariance, the concentric radial distribution improves scale robustness, and the spiral configuration enhances illumination resilience. Collectively, the sub-figures 402-408 demonstrate the generation of the one or more descriptor distributions used for the adaptive feature encoding and the subsequent re-identification between the target image and the query image.

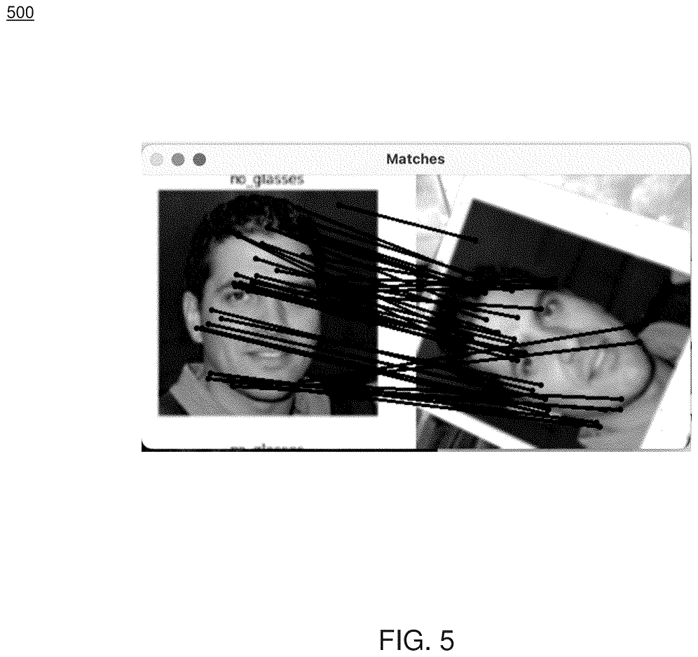

FIG. 5 illustrates an exemplary schematic representation 500 showing keypoint correspondence between a target image and a query image, in accordance with an embodiment of the present disclosure. The schematic representation demonstrates how the re-identification module 214 establishes the point-to-point matches between the descriptor features extracted from the two images using the one or more binary descriptors comparison.

The target image represents a reference frame of a subject without glasses. The query image represents the same subject with glasses under modified lighting conditions. The black connecting lines between the two images denote the matched keypoints identified through the nearest-neighbor or the Hamming-distance-based descriptor comparison. The correspondence lines visualize the feature re-identification process in which the local binary descriptors computed from the query image are matched with stored binary descriptors derived from the target image. The matched keypoints confirm that the descriptor distributions and the scoring modules effectively preserve feature distinctiveness under minor occlusions or illumination shifts.

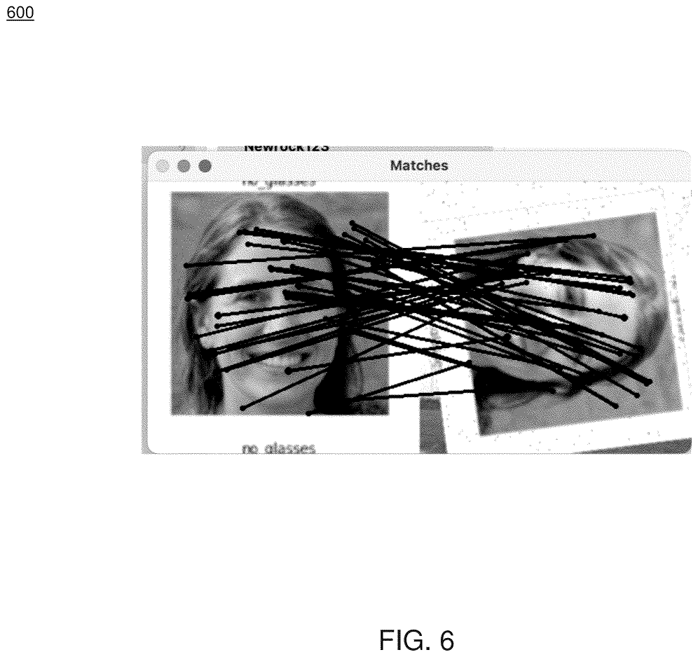

FIG. 6 illustrates an exemplary schematic representation 600 showing another example of keypoint correspondence between another target image and another query image, in accordance with another embodiments of the present disclosure. The figure demonstrates the robustness of the re-identification process when applied to a different subject or environmental condition.

In this example, the target image and the query images depict the same subject under varied pose and expression conditions. The re-identification module 214 identifies corresponding keypoints across both images, and the connecting lines represent valid descriptor matches. Despite geometric or photometric variations, the majority of keypoints remain successfully re-identified. The re-identification of the keypoints indicate that the descriptor generation and the scoring mechanisms maintain stability across transformations.

The figure visually reinforces the functionality of the tracking module 220 and the scoring module 216 in preserving the geometric consistency during the adaptive image tracking. The accurate keypoint mapping achieved across the two image pairs demonstrates that the system 108 effectively performs the feature re-identification, the descriptor evaluation, and the geometric verification to ensure reliable correspondence between the target and query images.

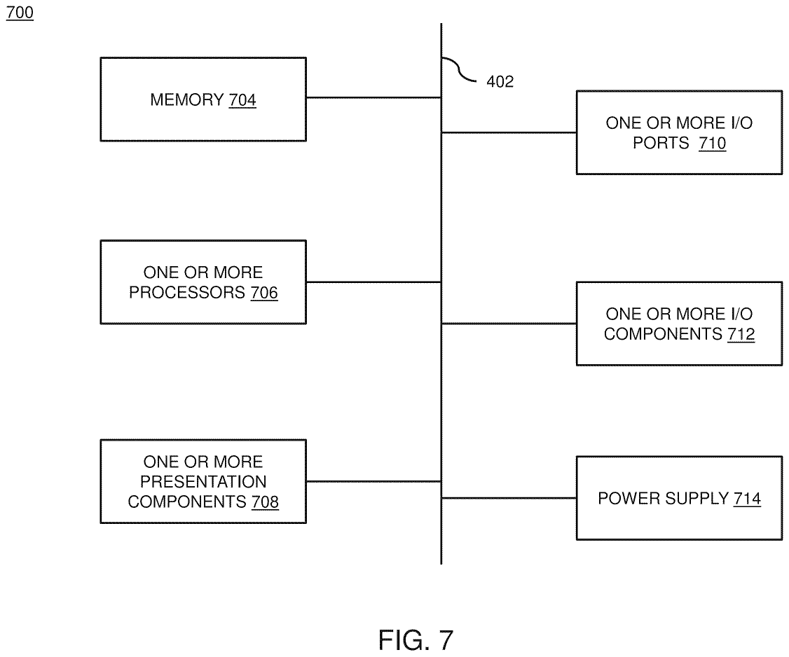

FIG. 7 illustrates an exemplary block diagram of a device 700 configured for executing the adaptive image tracking, in accordance with various embodiments of the present disclosure. The device 700 is representative of the user device 104 or any computing entity configured to operate the system 108 and execute the modules described in FIG. 2, including the keypoint detection, descriptor generation, scoring, and tracking processes. The device 700 may be implemented as a non-transitory computer-readable medium storing instructions for performing the adaptive image tracking, the re-identification, and the suitability score-based distribution selection in real time.

The device 700 includes a bus 702 that directly or indirectly couples a memory 704, one or more processors 706, one or more presentation components 708, one or more input/output (I/O) ports 710, one or more I/O components 712, and a power supply 714. The bus 702 represents one or more communication channels, such as an address bus, data bus, or control bus, enabling high-speed data transfer and synchronization among the device components during real-time image tracking operations.

In practice, the delineation between various components may not be strict, and several elements may overlap in functionality. For example, a presentation component such as a display may also function as an I/O component, and a processor 706 may integrate internal cache or embedded memory. The illustration in FIG. 7 is therefore exemplary and non-limiting, serving as a logical representation of hardware elements that collectively enable descriptor-based keypoint detection, re-identification, and adaptive tracking.

The device 700 includes one or more types of computer-readable media accessible to the one or more processors 706. The computer-readable media may include volatile or non-volatile, removable or non-removable storage that retains data, descriptors, and executable program instructions. The memory 704 stores operational data such as descriptor distributions, binary feature maps, and suitability scores generated during runtime.

The computer storage media may include random-access memory (RAM), read-only memory (ROM), flash memory, solid-state drives, or other media capable of storing instructions. The communication media may carry encoded data or instructions in a modulated signal transmitted through wired or wireless channels, such as Wi-Fi, 5G, Bluetooth, or ultra-wideband links used for synchronization between devices or cloud servers during distributed tracking.

The memory 704 stores computer-readable instructions that, when executed by the one or more processors 706, cause the device 700 to perform the operations of detecting the plurality of keypoints, generating the one or more descriptor distributions, computing the one or more binary descriptors, re-identifying the plurality of keypoints across the query images, and evaluating the distribution suitability scores. In an embodiment, the memory 704 maintains buffers for intermediate data such as feature tensors, frame sequences, and homography matrices derived during geometric verification. The memory 704 may store reference patterns or pre-trained model weights used for descriptor optimization.

The one or more processors 706 execute the instructions stored in the memory 704 to perform computational operations required for the keypoint detection and the tracking. The one or more processors 706 may include central processing units (CPUs) for control logic, graphics processing units (GPUs) for parallel descriptor generation, and digital signal processors (DSPs) for pixel-intensity analysis. In certain embodiments, the one or more processors 706 may include neural processing units (NPUs) or tensor accelerators configured to execute machine-learning models for the adaptive descriptor selection and scoring. The one or more processors 706 cooperate to achieve low-latency inference and continuous tracking stability across sequential frames.

The one or more presentation components 708 generate perceptible output for the user 102. Examples include a high-resolution display, a head-mounted display (HMD), or an augmented-reality visor rendering tracking overlays and positional feedback in real time. In an embodiment, the one or more presentation components 708 visualize the detected plurality of keypoints, bounding regions, or re-identified objects, allowing a user to observe tracking accuracy and scene alignment dynamically.

The one or more I/O ports 710 facilitate communication between the device 700 and external systems, peripheral sensors, or servers. Examples include USB-C, HDMI, DisplayPort, or Thunderbolt interfaces used to connect external cameras, lighting sensors, or calibration tools. The one or more I/O components 712 serve as input mechanisms for acquiring image data and environmental context. Illustrative I/O components 712 include RGB cameras, depth sensors, LiDAR units, IMUs (inertial measurement units), or photometric sensors that provide orientation and motion data to improve descriptor robustness.

The power supply 714 provides the necessary energy for device operation. The power supply 714 may include a rechargeable lithium-ion battery for mobile devices or a wired AC/DC unit for workstations and servers executing the tracking pipeline. In some embodiments, the power supply 714 employs dynamic power management, selectively scaling processor frequency during idle frames to conserve energy without compromising real-time performance.

During operation, the one or more processors 706, the memory 704, and the I/O components 712 function in a closed feedback loop to capture sequential images, compute descriptor distributions, and track the re-identified plurality of keypoints across frames. The data generated through the process is processed by the system 108 to derive the transformation matrices and positional updates for mixed-reality alignment. The one or more presentation components 708 render the tracking results to the user 102, displaying the tracked target image or recognized objects within the physical environment.

In an embodiment, the device 700 communicates with a remote processing server or cloud-based inference engine to offload computation-intensive modules, such as global descriptor optimization, distribution retraining, or temporal scoring aggregation. The distributed architecture enables hybrid processing between local and remote nodes, enhancing scalability, reducing latency, and maintaining tracking precision across multiple user devices.

The arrangement of components shown in FIG. 7 is illustrative and non-restrictive. Additional or fewer components may be included based on implementation requirements. Functions performed by one component may alternatively be distributed across multiple modules. The device 700 is therefore representative of a flexible and scalable computing architecture capable of executing real-time adaptive image tracking, dynamic descriptor optimization, and continuous re-identification under variable illumination and motion conditions across heterogeneous computing environments.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for adaptive image tracking, the system comprising:
one or more processors; and
a non-transitory memory communicatively coupled to the one or more processors, wherein the memory stores instructions that, when executed by the one or more processors, cause the system to:
receive, using a receiving module, a target image and a query image of a physical environment, wherein the target image represents a reference view and the query image represents a physical region containing the target image;
detect, using a keypoint detection module, a plurality of keypoints in the target image captured by one or more sensors of a user device;
generate, using a descriptor generation module, one or more descriptor distributions for each of the detected plurality of keypoints, wherein each of the one or more descriptor distribution defines a spatial sampling pattern of pixel-pair intensity relationships around the plurality of keypoints;
compute, using a feature computation module, one or more binary descriptors for the plurality of keypoints based on the generated one or more descriptor distributions, wherein the one or more binary descriptors representing local intensity comparisons around each of the plurality of keypoints;
re-identify, using a re-identification module, the plurality of keypoints of the target image in the query image by comparing one or more binary descriptors computed from the query image with the stored one or more binary descriptors corresponding to the target image;
evaluate, using a scoring module, one or more descriptor distributions associated with the re-identified plurality of keypoints to determine a distribution suitability score;
select, using a distribution selection module, an optimal descriptor distribution for the query image based on the determined suitability score; and
track, using a tracking module, the target image across a sequence of frames captured by the user device based on point-to-point correspondence between the one or more binary descriptors derived from the selected descriptor distribution.

2. The system of claim 1, wherein the one or more descriptor distributions are generated using a parameterized spatial function defining a pixel sampling pattern based on at least one of amplitude, frequency, or phase offset parameters.

3. The system of claim 1, wherein the evaluation of the one or more descriptor distributions is performed using one or more performance parameters comprising at least re-identification accuracy, tracking stability, affine-transformation tolerance, descriptor distinctiveness, and illumination robustness.

4. The system of claim 1, wherein the feature computation module generates the one or more binary descriptors by comparing relative pixel-intensity pairs within each sampling pattern to produce rotation-and scale-invariant descriptor encodings.

5. The system of claim 1, wherein the re-identification module performs descriptor matching using a nearest-neighbor search or a Hamming-distance-based similarity computation between the one or more binary descriptors of the query image and the stored one or more binary descriptors of the target image.

6. The system of claim 1, wherein the system stores the one or more descriptor distributions for each of the plurality of keypoints and dynamically switches to an alternate descriptor distribution when the suitability score associated with the re-identified plurality of keypoints falls below a pre-defined threshold.

7. The system of claim 1, wherein the scoring module assigns the weighted distribution suitability score based on a combination of descriptor distinctiveness and temporal stability of the re-identified plurality of keypoints across a plurality of frames of the query image.

8. The system of claim 1, wherein the tracking module performs geometric consistency verification by estimating a homography matrix from matched descriptor pairs and rejecting outlier correspondences exceeding a defined deviation threshold.

9. The system of claim 1, wherein the system continuously updates the descriptor distribution suitability score based on temporal frame analysis to maintain tracking stability under dynamic illumination or motion variations.

10. The system of claim 1, wherein the re-identification module constructs a mapping matrix between the matched descriptor pairs of the target image and the query image, wherein the mapping matrix represents a geometric transformation derived from the descriptor correspondences.

11. The system of claim 1, wherein the tracking module projects the matched keypoints into a three-dimensional coordinate system using intrinsic and extrinsic camera parameters, and wherein the tracking module continuously tracks a spatial position of the query image within the three-dimensional scene using the mapped descriptors.

12. A computer-implemented method for performing adaptive image tracking, the method comprising:
receiving a target image and a query image of a physical environment, wherein the target image represents a reference view and the query image represents a physical region containing the target image;
detecting a plurality of keypoints in the target image captured by one or more sensors of a user device;
generating one or more descriptor distributions for each of the detected plurality of keypoints, wherein each of the one or more descriptor distributions define a spatial sampling pattern of pixel-pair intensity relationships around the plurality of keypoints;
computing one or more binary descriptors for the plurality of keypoints based on the generated one or more descriptor distributions, wherein the one or more binary descriptors representing local intensity comparisons around each of the plurality of keypoints;
re-identifying the plurality of keypoints of the target image in the query image by comparing one or more binary descriptors computed from the query image with the stored one or more binary descriptors corresponding to the target image;
evaluating one or more descriptor distributions associated with the re-identified plurality of keypoints to determine a distribution suitability score;
selecting an optimal descriptor distribution for the query image based on the determined suitability score; and
tracking the target image across a sequence of frames captured by the user device based on point-to-point correspondence between the one or more binary descriptors derived from the selected descriptor distribution.

13. The computer-implemented method of claim 12, wherein the one or more descriptor distributions are generated using a parameterized spatial function defining a pixel sampling pattern based on at least one of amplitude, frequency, or phase offset parameters.

14. The computer-implemented method of claim 12, wherein evaluating the one or more descriptor distributions comprises computing one or more performance parameters, wherein the one or more performance parameters comprise re-identification accuracy, tracking stability, affine-transformation tolerance, descriptor distinctiveness, and illumination robustness.

15. The computer-implemented method of claim 12, wherein computing the one or more binary descriptors comprises comparing relative pixel-intensity pairs within each sampling pattern to produce rotation-invariant and scale-invariant descriptor encodings.

16. The computer-implemented method of claim 12, further comprising storing the one or more descriptor distributions for each of the plurality of keypoints and dynamically switching to an alternate descriptor distribution when the distribution suitability score falls below a predefined threshold.

17. The computer-implemented method of claim 12, wherein the distribution suitability score is determined based on a combination of descriptor distinctiveness and temporal stability of the re-identified plurality of keypoints across a plurality of frames of the query image.

18. The computer-implemented method of claim 12, wherein the descriptor distribution suitability score is updated continuously based on temporal frame analysis to maintain tracking stability under dynamic illumination variations or motion conditions.

19. The computer-implemented method of claim 12, wherein the tracking of the target image comprises projecting matched keypoints into a three-dimensional coordinate system using intrinsic and extrinsic camera parameters and continuously estimating a spatial position of the query image within the three-dimensional scene using the mapped descriptors.

20. A non-transitory computer-readable medium storing instructions that, when executed by one or more processors of a computing system, cause the computing system to perform a computer-implemented method for adaptive image tracking within a physical environment, the method comprising:
receiving a target image representing a reference view of the physical environment and a query image representing a physical region containing the target image;
detecting a plurality of keypoints in the target image captured by one or more image sensors of a user device;
generating, for each detected keypoint, one or more descriptor distributions defining respective spatial sampling patterns of pixel-pair intensity relationships around the detected keypoints;
computing one or more binary descriptors for the plurality of keypoints by performing local pixel-intensity comparisons in accordance with the generated descriptor distributions;
re-identifying the plurality of keypoints of the target image within the query image by comparing binary descriptors computed from the query image with stored binary descriptors corresponding to the target image;
evaluating descriptor distributions associated with the re-identified plurality of keypoints to determine a distribution suitability score indicative of tracking robustness;
selecting an optimal descriptor distribution for the query image based on the determined distribution suitability score; and
tracking the target image across a sequence of frames captured by the user device by establishing point-to-point correspondence between binary descriptors derived using the selected descriptor distribution.
